(19) United States
(12) Patent Application Publication
(10) Pub. No.: US 2025/0058967 A1
(43) Pub. Date: Feb. 20, 2025

(54) Trash Container Liner Dispenser

(71) Applicant: Cindy Shaw, Tupelo, MS (US)

(72) Inventor: Cindy Shaw, Tupelo, MS (US)

(21) Appl. No.: 18/808,507

(22) Filed: Aug. 19, 2024

Related U.S. Application Data
(60) Provisional application No. 63/533,503, filed on Aug. 18, 2023.
(60) Provisional application No. 63/647,328, filed on May 14, 2024.

(51) Int. Cl. B65F 1/06; B65D 83/08; B65F 1/16

(52) U.S. Cl. CPC B65F 1/062; B65D 83/0847; B65F 1/1646

(57) ABSTRACT

Disclosed herein are dispensers for trash container liners, and trash container assemblies including the same. Such dispensers generally comprise a first wall and a second wall that meet at an apex of the dispenser and define an interior space. The interior space can contain one or more trash container liners. The apex of the dispenser includes an opening that receives a trash container liner extending from the interior space to an exterior of the dispenser. The dispensers disclosed herein can generally be placed in the bottom of a trash container, and may be permanently or releasably secured there.

### CROSS-REFERENCES TO RELATED APPLICATIONS

This application claims benefit of U.S. Provisional Patent Application No. 63/533,503, filed on Aug. 18, 2023, and U.S. Provisional Patent Application No. 63/647,328, filed on May 14, 2024, both of which are hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD

The present disclosure relates generally to the field of trash container and trash container liners. More particularly, the disclosure relates to a trash container liner dispenser operable for use with conventional trash containers and rolls of trash container liners.

### BACKGROUND

Trash containers may be operable to receive trash and other waste materials. Trash container liners are often used to line the interior of the trash container. The trash container liner may be operable to prevent the trash container from coming into contact with the waste materials, thus preserving the cleanliness of the trash container. Trash container liners may also ease the process of emptying waste materials from the trash container. When the trash container liner is removed from the trash container, a user typically retrieves a new trash container liner stored in a separate location from the trash container, such as a pantry or storage closet.

Trash container liners are often sold in boxes containing a roll of the trash container liners. The roll of trash container liners typically are not mounted to a spindle or other element that may act as a central member to the roll. Instead, the roll simply consists of a plurality of trash container liners.

One of skill in the art will appreciate that trash container liner dispensers exist in the prior art but have several shortcomings. One such shortcoming may be that prior art trash container liner dispensers require specialty trash containers to be used. For example, many of these prior art trash container liner dispensers are in the form of a base that must be attached to a specific trash container. Another shortcoming may be that prior art trash container liner dispensers require the roll of trash container liners to be mounted to a spindle or other central member. Thus, conventional rolls of trash container liners may not be used directly from the box in which they are packaged. Rather, specialty rolls of trash container liners must be purchased that are mounted to a spindle or a user must mount the trash container liners to a spindle that forms a part of the trash container liner dispenser. Thus, these prior art trash container liner dispensers may require a plurality of parts making them difficult to install and use. A final shortcoming may be that prior art trash container liner dispensers allow for waste materials leaking in the trash container to contact the roll of trash container liners, thus soiling the clean trash container liners prior to use.

Accordingly, a need exists for improvements in trash container liner dispensers.

### SUMMARY

This Summary of the Disclosure is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect in accordance with the optional embodiments disclosed herein is a dispenser for trash container liners. The dispenser may comprise a triangular body, an opening, at least two triangular supports, and an interior. The triangular body may have first and second wall. The first and second walls may meet along an apex of the body. The opening may be defined in the body along a portion of the apex. The opening may be configured to receive a trash container liner therethrough. The at least two triangular supports may be positioned between the first and second walls of the body. The at least two triangular supports may extend perpendicular to the first and second walls. The interior may be defined by the first and second walls and first and second supports. The interior may be operable to receive a plurality of the trash container liners. The dispenser may be configured to be coupled to a floor of a trash container at a central portion.

Certain examples concern a dispenser for trash container liners. The dispenser comprises, a body having first and second walls, the first and second walls meeting along an apex of the body. The dispenser also comprises an opening defined in the body along a portion of the apex, the opening configured to receive a trash container liner through the opening and an interior defined by the first and second walls, the interior operable to receive a plurality of the trash container liners. The dispenser is configured to be coupled to a floor of a trash container at a central portion.

Certain examples concern trash container assembly. The trash container assembly comprises a trash container defining an interior space and having an opening along a floor of the trash container and selectively removable cover disposed over the opening. The trash container assembly also includes a dispenser positioned along the floor of the trash container. The dispenser comprises a body having first and second walls, the first and second walls meeting along an apex of the body, an opening defined in the body along a portion of the apex, the opening configured to receive a trash container liner therethrough, and an interior defined by the first wall and the second wall, the interior operable to receive a plurality of the trash container liners. When the selectively removable cover is removed from the opening in the floor of the trash container, a trash container liner may be admitted to the interior of the dispenser through the opening.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is a perspective view of an optional embodiment of a trash container liner dispenser in accordance with one aspect of the present disclosure.

FIG. 2 is a perspective view of the optional embodiment of the trash container liner dispenser of FIG. 1 in accordance with one aspect of the present disclosure.

FIG. 3 is a bottom view of the optional embodiment of the trash container liner dispenser of FIG. 1 in accordance with one aspect of the present disclosure.

FIG. 4 is a bottom view of the optional embodiment of the trash container liner dispenser of FIG. 1 in accordance with one aspect of the present disclosure.

FIG. 5 is a side view of the optional embodiment of the trash container liner dispenser of FIG. 1 in accordance with one aspect of the present disclosure.

FIG. 6 is a side view of the optional embodiment of the trash container liner dispenser of FIG. 1 in accordance with one aspect of the present disclosure.

FIG. 7 is a side view of another optional embodiment of a trash container liner dispenser in accordance with one aspect of the present disclosure.

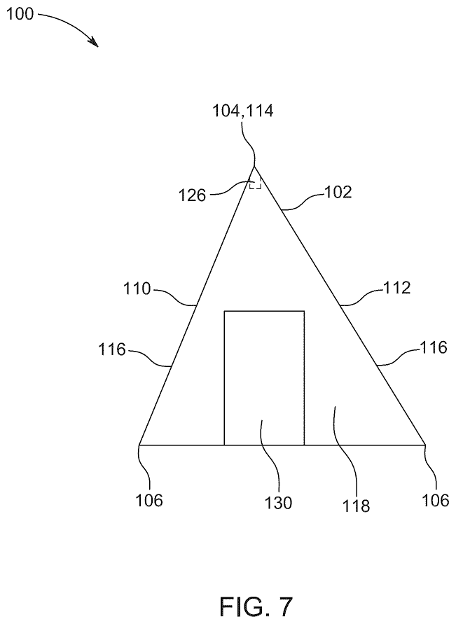

FIG. 8 is a top view of another optional embodiment of a trash container liner dispenser in accordance with one aspect of the present disclosure.

FIG. 9 is a sectioned side view of the optional embodiment of the trash container liner dispenser of FIG. 1 in accordance with one aspect of the present disclosure wherein the trash container liner dispenser is coupled to a trash container.

FIG. 10 is a top view of the optional embodiment of the trash container liner dispenser of FIG. 1 in accordance with one aspect of the present disclosure wherein the trash container liner dispenser is coupled to the trash container.

FIG. 11 is a bottom view of the optional embodiment of the trash container liner dispenser of FIG. 1 in accordance with one aspect of the present disclosure wherein the trash container liner dispenser is coupled to the trash container.

FIG. 12 is a bottom view of the optional embodiment of the trash container liner dispenser of FIG. 1 in accordance with one aspect of the present disclosure wherein the trash container liner dispenser is coupled to the trash container.

FIG. 13 is a schematic view of a prior art trash container.

FIG. 14 is a perspective view of another optional embodiment of a trash container liner dispenser in accordance with one aspect of the present disclosure.

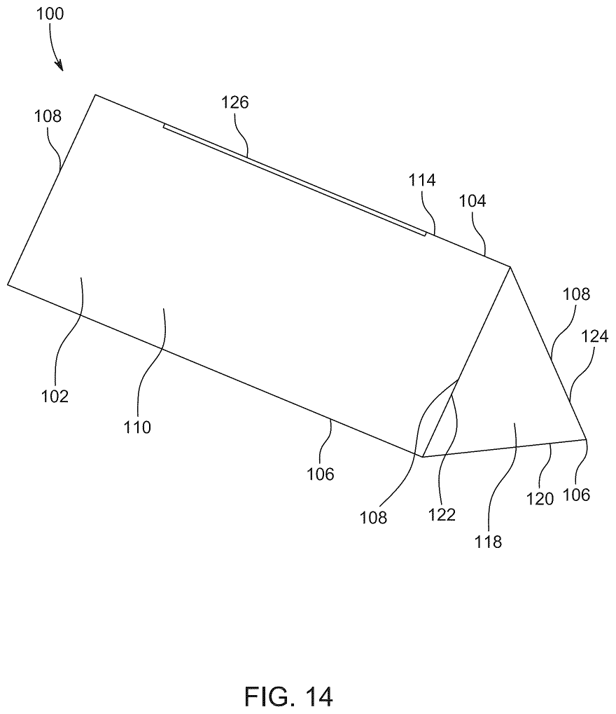

FIG. 15 is a top view of the optional embodiment of the trash container liner dispenser of FIG. 1 in accordance with one aspect of the present disclosure wherein the trash container liner dispenser is coupled to the trash container.

FIG. 16 is a top view of the optional embodiment of the trash container liner dispenser of FIG. 1 in accordance with one aspect of the present disclosure wherein the trash container liner dispenser is coupled to the trash container.

FIG. 17 is a bottom view of the trash container of FIG. 16 with a selectively removable cover.

FIG. 18 is a bottom view of the trash container of FIG. 16 with a selectively removable cover.

FIG. 19 is a side view of a trash container according to another aspect of the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof. Furthermore, any part of the apparatus of the present disclosure may be made using any applicable manufacturing method, such as, but not limited to 3D printing, injection molding, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

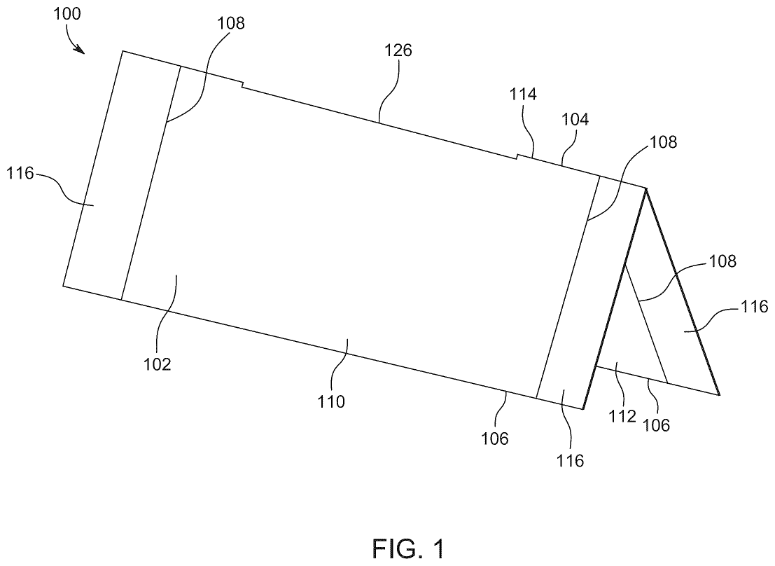

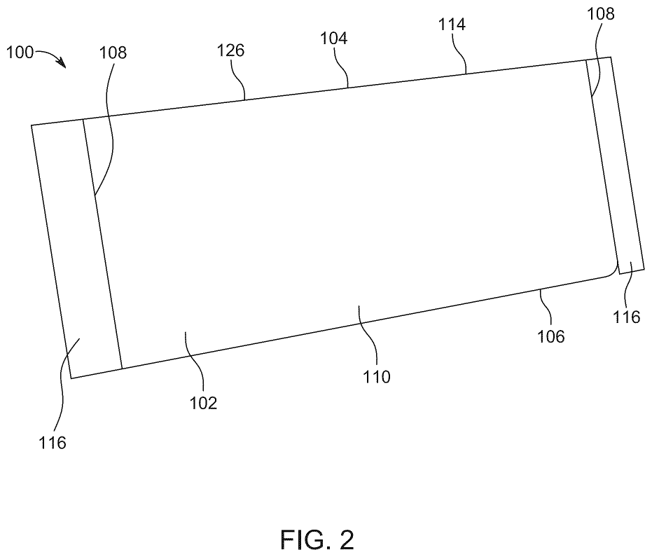

Referring now to the figures, and specifically FIGS. 1 and 2, a trash container liner dispenser is shown and generally designated by the number 100. The trash container liner dispenser 100 may be referred to herein as simply the dispenser 100. The trash container liner dispenser 100 may be operable to receive and selectively dispense a conventional trash container liner 10.

In one optional embodiment of the trash container liner dispenser 100, the dispenser 100 includes main body 102. The main body 102 may be in the shape of an inverted V or triangle. However, it may be within the spirit of the present disclosure for the main body 102 to be shaped in an alternative way. The trash container liner dispenser 100 may have a top 104, a bottom 106, and end portions 108.

The main body 102 may include a first wall 110 and a second wall 112. In certain optional embodiments of the trash container liner dispenser 100, the first wall 110 and the second wall 112 of the main body 102 may be formed from a single piece of material folded along an apex 114. The apex 114 of the main body 102 may generally be located at the top 104 of the main body 102. In other optional embodiments of the trash container liner dispenser 100, the first wall 110 and the second wall 112 may be formed from separate pieces of material that meet at the apex 114. The first and second walls 110, 112 may be identical and thus the trash container liner dispenser 100 may be positioned in a variety of configurations wherein the first and second walls 110, 112 swap places without altering the overall functionality of the trash container liner dispenser 100.

In certain optional embodiments of the trash container liner dispenser 100, the trash container liner dispenser 100 may include a plurality of end strips 116. Each of the plurality of end strips 116 may also be generally designed by the number 116. Each of the plurality of end strips 116 may be located at or near the end portions 108 of the main body 102. In optional embodiments of the trash container liner dispenser 100 wherein the first wall 110 and second wall 112 of the main body 102 are formed from a single piece of material, the trash container liner dispenser 100 may include an end strip 116 located at or near the end portions 108 of the main body 102. Thus, the trash container liner dispenser 100 may include a total of two (2) end strips 116. In optional embodiments of the trash container liner dispenser 100 wherein the first wall 110 and the second wall 112 of the main body 102 are formed from separate pieces of material, the trash container liner dispenser 100 may include an end strip 116 located at or near each end portion 108 of the first wall 110 and an end strip 116 located at each end portion 108 of the second wall 112. Thus, the trash container liner dispenser 100 may include a total of four (4) end strips 116.

The plurality of end strips 116 may be removably coupled to the first wall 110 and second wall 112 of the main body 102 such that each of the end strips 116 may be selectively removed from the main body 102 when so desired. In certain optional embodiments of the trash container liner dispenser 100, the connection between the plurality of end strips 116 and the main body 102 may be perforated such that the end strips 116 may be easily removed from the main body 102. In other optional embodiments of the trash container liner dispenser 100, the plurality of end strips 116 may be coupled to the main body 102 via an adhesive element, such as glue or tape to name a few examples. Advantageously the end strips 116 can, in such examples, thereby laterally secure the first wall 110 to the trash container.

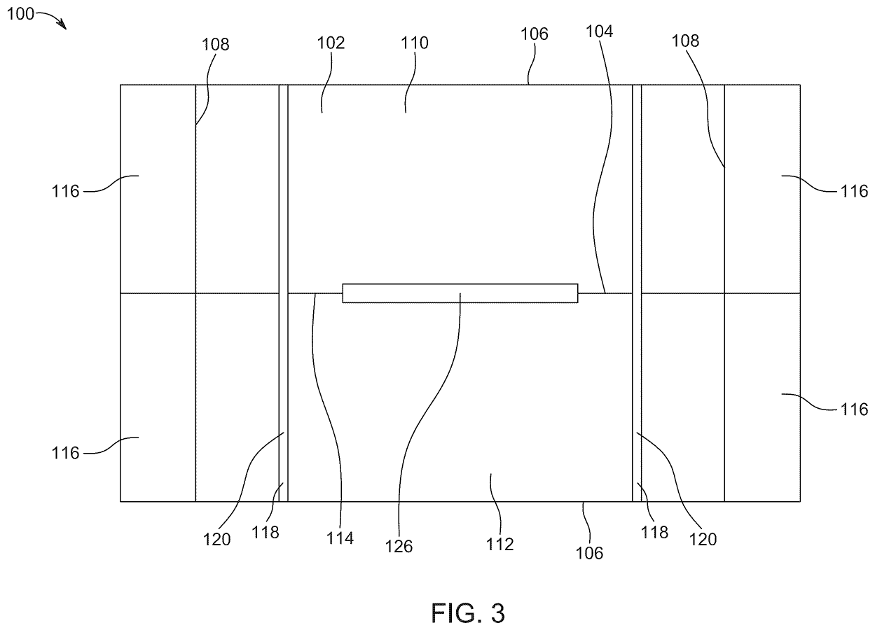

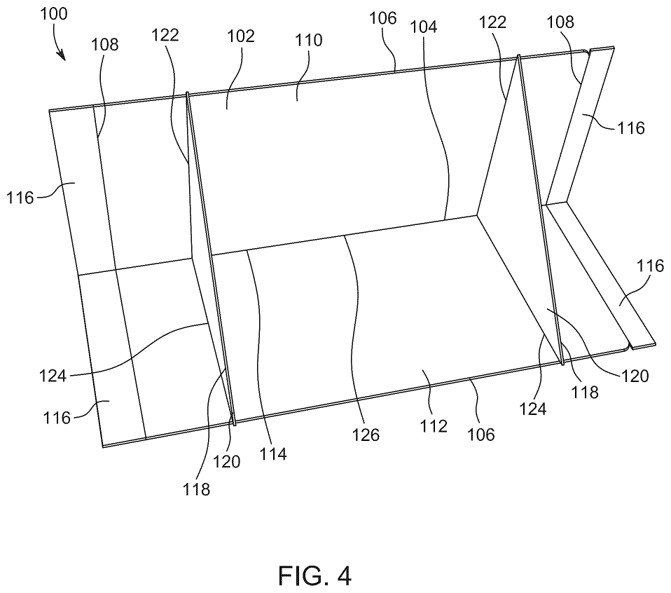

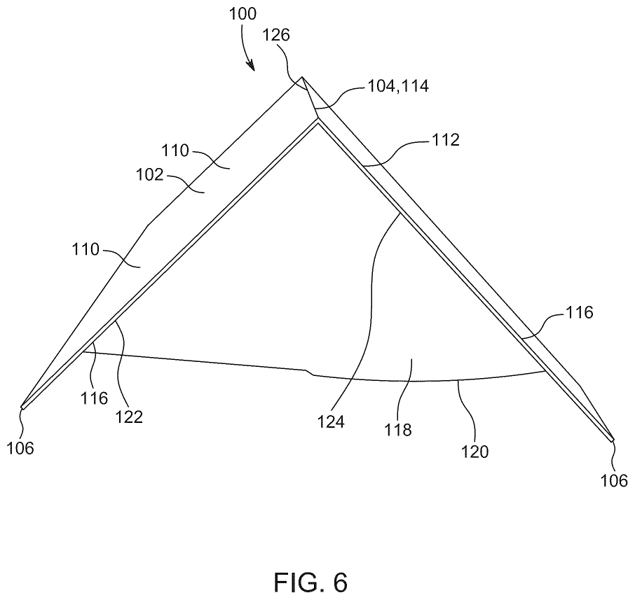

Referring now to FIGS. 3-4 and 6, the trash container liner dispenser 100 may include a plurality of supports 118. Each of the plurality of supports 118 may be triangular in shape. Each of the plurality of supports 118 may include a bottom edge 120, a first angled edge 122, and a second angled edge 124. The bottom edge 120 of each of the plurality of supports 118 may span across the bottom 106 of the main body 102 from the first wall 110 to the second wall 112. The first angled edge 122 may span along an interior of the first wall 110 and be coupled thereto. The second angled edge 124 may span along an interior of the second wall 112 and be coupled thereto. The plurality of supports 118 may provide structure and strength to the trash container liner dispenser 100, and specifically to the main body 102. In the illustrated embodiment, the trash container liner dispenser 100 includes two (2) supports 118, with a first support plurality of supports 118 laterally spaced apart from the a second support 118. However, in other optional embodiments, the trash container liner dispenser 100 may include only a single support 118 or more than two (2) supports 118.

According to some aspects of the present disclosure, the trash container liner dispenser 100 can also include a base extending between a bottom end portion first wall 110 and a bottom end portion of the second wall 112. The base can be in lieu of or in addition to the one or more supports 118 previously described.

As shown in FIGS. 1, 3, and 5, among others, the trash container liner dispenser 100 may include an opening 126 defined in the main body 102. Specifically, the opening 126 may be located along a portion of the apex 114 of the main body 102. In optional embodiments wherein the first wall 110 and second wall 112 of the main body 102 are formed from a single piece of material, the opening 126 may be cut from the main body 102 along the apex 114. In optional embodiments wherein the first wall 110 and the second wall 112 of the main body 102 are formed from separate pieces of material, the opening 126 may be a portion along the apex 114 where the first wall 110 and second wall 112 are not permanently or releasably coupled.

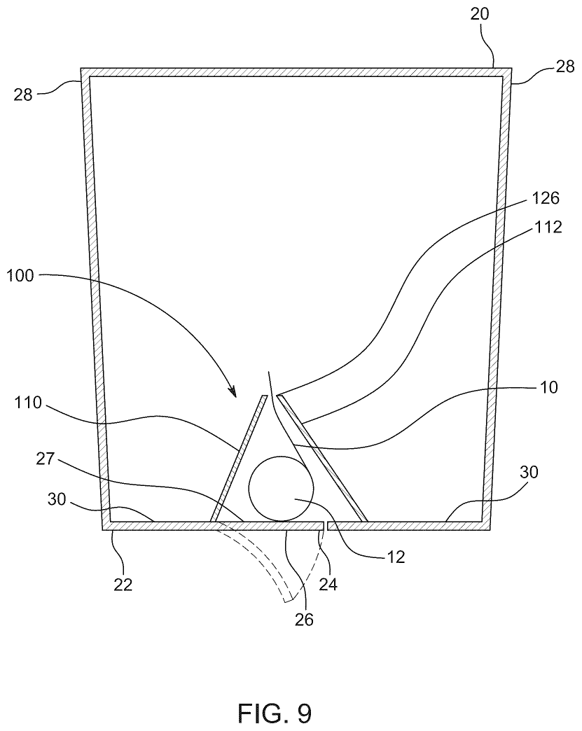

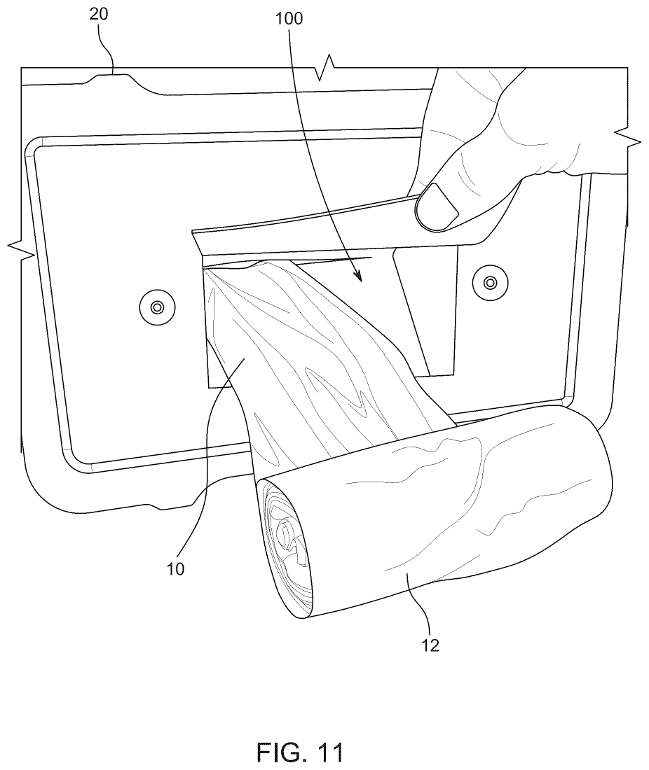

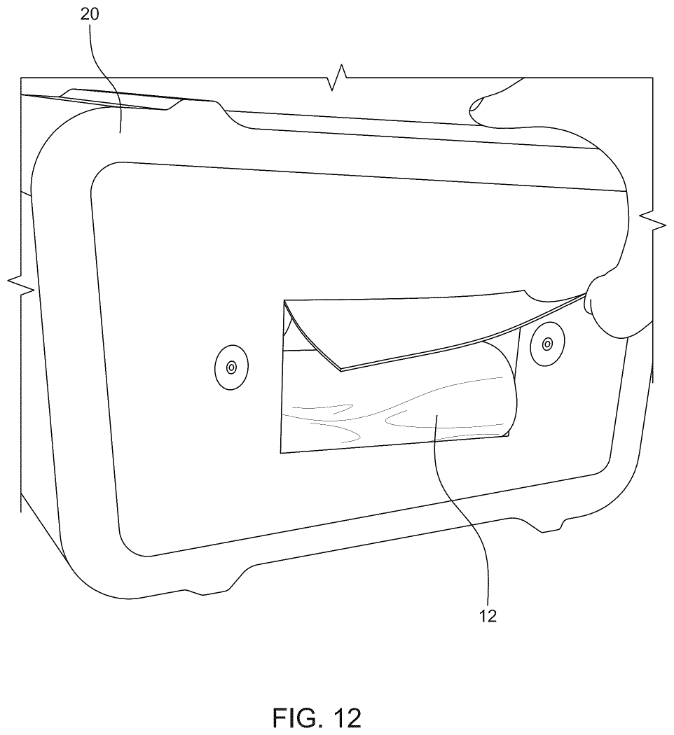

As shown in FIGS. 9-12, the trash container liner dispenser 100 may be configured to receive a one or more trash container liners 10. The one or more trash container liners 10 may be configured as a roll 12 of trash container liners 10. The one or more trash container liners 10 may be wrapped around a spindle to create the roll 12, or the one or more trash container liners 10 may be generally rolled without a spindle to create the roll 12. The trash container liners 10 of the roll 12 may be coupled to each other via a perforated connection. The perforated connection may allow for the trash container liners 10 to be separated when acted on by a requisite force. The roll 12 of conventional trash container liners 10 may include an outer trash container liner 10 that constitutes the exposed end of the roll 12. Thus, one advantage of the current disclosure may be that the roll 12 of the one or more trash container liners 10 does not need to be mounted on a spindle. This may eliminate the need to buy specialty trash container liners 10 that are packaged already mounted on a spindle or to manually mount conventional trash container liners 10 to a spindle.

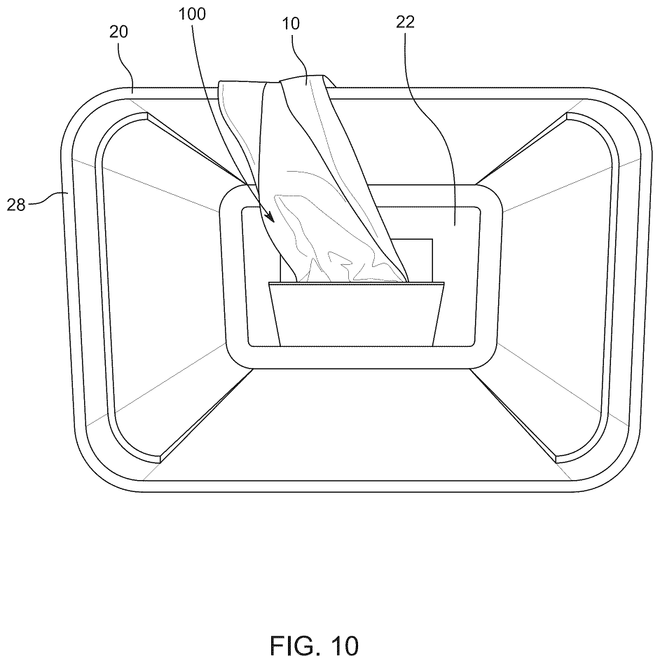

The trash container liner dispenser 100 may specifically be configured to receive the one or more trash container liners 10 within an interior of the main body 102. As shown in FIG. 9, the interior of the main body 102 may be defined by the first wall 110, second wall 112, and between the supports 118. The outer trash container liner 10 may be pulled through the opening 126 of the main body 102 of the trash container liner dispenser 100 as shown in FIGS. 9 and 10. The opening 126 may be configured such that the outer trash container liner 10 may be separated from the roll 12 along the perforated connection. In certain optional embodiments of the trash container liner dispenser 100, a pressure between the first wall 110 and second wall 112 at the opening 126 may cause the outer trash container liner 10 to separate from the roll 12 at the perforated connection. In other optional embodiments of the trash container liner dispenser 100, a user may cause the perforated connection between the outer trash container liner 10 and the roll 12 to engage the first wall 110 or second wall 112 such that the first wall 110 or second wall 112 may cause the outer trash container liner 10 to separate from the roll 12 at the perforated connection.

In certain optional embodiments of the trash container liner dispenser 100, the dispenser 100 may be configured to be coupled to a trash container 20. Specifically, the trash container liner dispenser 100 may be positioned within an interior space of the trash container 20 and configured to be coupled to an interior of the trash container 20 at a floor 22.

In one optional embodiment of the trash container liner dispenser 100, the trash container liner dispenser 100 may be permanently coupled to the floor 22 of the trash container 20 or formed thereto. Referring now to FIG. 9, the trash container 20 may include an opening 24 defined in the floor 22. The opening 24 may be selectively covered by a covering 26 (which in some cases can be a selectively removable cover) disposed over or within the opening 24. Thus, the roll 12 of trash container liners 10 may be loaded into the interior of the trash container liner dispenser 100 through the opening 24 in the floor 22 of the trash container 20.

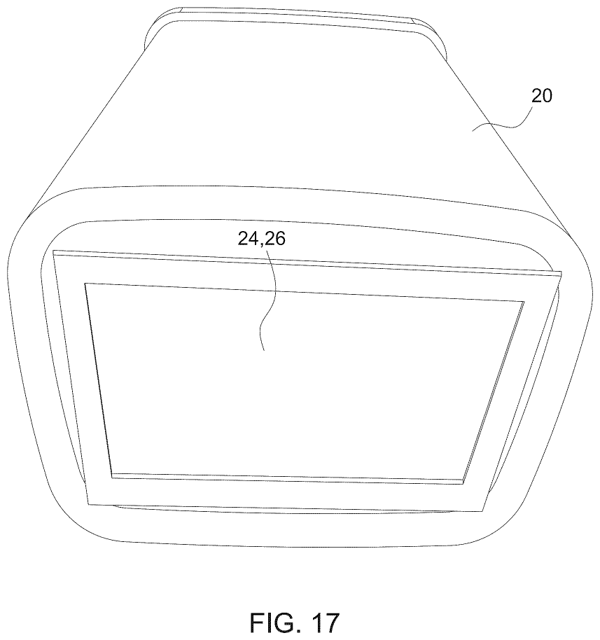

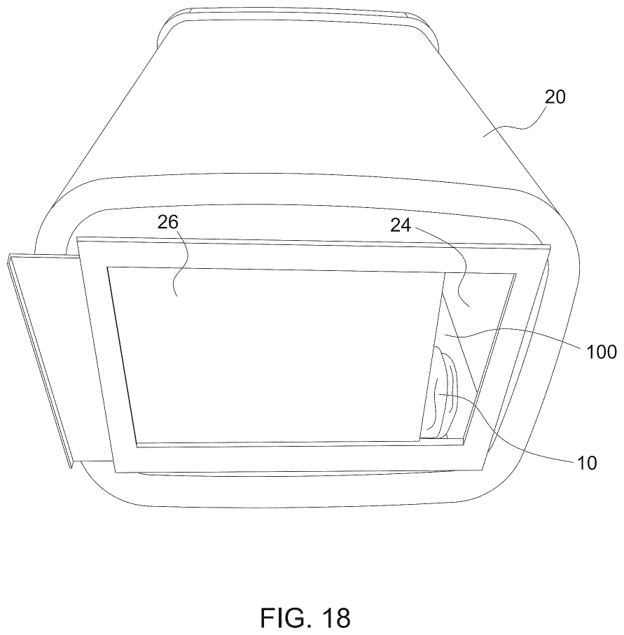

As shown in FIGS. 17 and 18, the covering 26 (for example, a selectively removable cover) may be slidably coupled to the trash container 20. According to one aspect of the present disclosure, the covering 26 may slide/translate relative to the trash container 20. The covering 26 may be movable between a closed configuration wherein the covering 26 substantially covers the opening 24 and an open configuration wherein the covering 26 is moved such that the opening 24 is exposed. According to another aspect of the present disclosure, the covering 26 can be a flexible flap attached along one edge to a rim of the opening 24. According to another aspect of the present disclosure, the covering 26 can be mounted to the opening 24 on a hinge, allowing the covering 26 to pivotally move between an open position and a closed position.

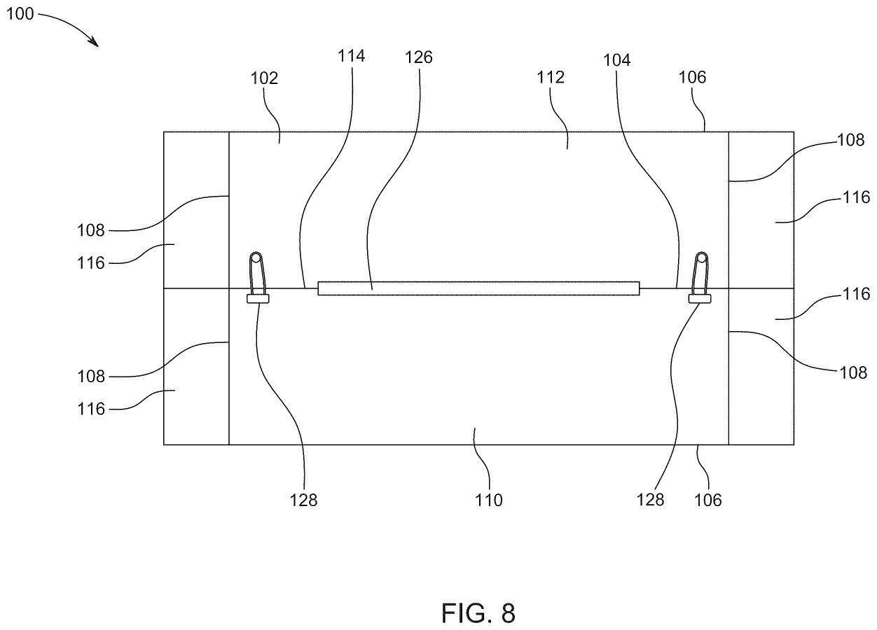

In another optional embodiment of the trash container liner dispenser 100, the trash container liner dispenser 100 may be permanently coupled to the floor 22 of the trash container 20 or formed thereto. The first wall 110 and the second wall 112 may be formed from separate pieces of material. The first wall 110 and second wall 112 may separate along the apex 114 to expose the interior of the trash container liner dispenser 100. A plurality of releasable fasteners 128 (for example, latches 128 as illustrated in FIG. 8) may be operable to selectively latch the first wall 110 to the second wall 112. Thus, the roll 12 of trash container liners 10 may be loaded into the interior of the trash container liner dispenser 100 by decoupling the first wall 110 from the second wall 112 and inserting or admitting the roll 12 of trash container liners 10 through the open top 104 of the trash container liner dispenser 100 when the first wall 110 and second wall 112 are unlatched from each other and separated.

In another optional embodiment of the trash container liner dispenser 100, the trash container liner dispenser 100 may be removably coupled to the floor 22 of the trash container 20. The trash container 20 may include the opening 24 in the floor 22 for loading the roll 12 of trash container liners 10 into the trash container liner dispenser 100. The first wall 110 and second wall 112 of the trash container liner dispenser 100 may separate along the apex 114 for loading the roll 12 of trash container liners 10 into the trash container liner dispenser 100 from the top 104. Alternatively, the trash container liner dispenser 100 may be at least partially removed from the floor 22 of the trash container 20 such that the roll 12 of trash container liners 10 may be loaded into the trash container liner dispenser 100.

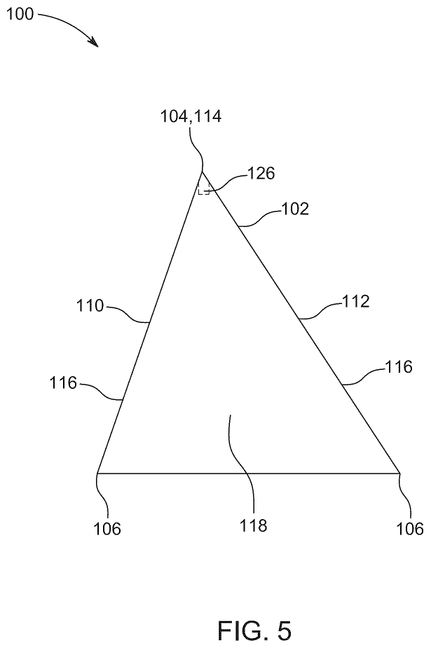

Referring now to FIG. 5, in another optional embodiment of the trash container liner dispenser 100, the trash container liner dispenser 100 may include a loading door 130 defined in one of the plurality of supports 118. The loading door 130 may be operable to be selectively opened, thus allowing a user to load the roll 12 of trash container liners 10 into the interior of the trash container liner dispenser 100.

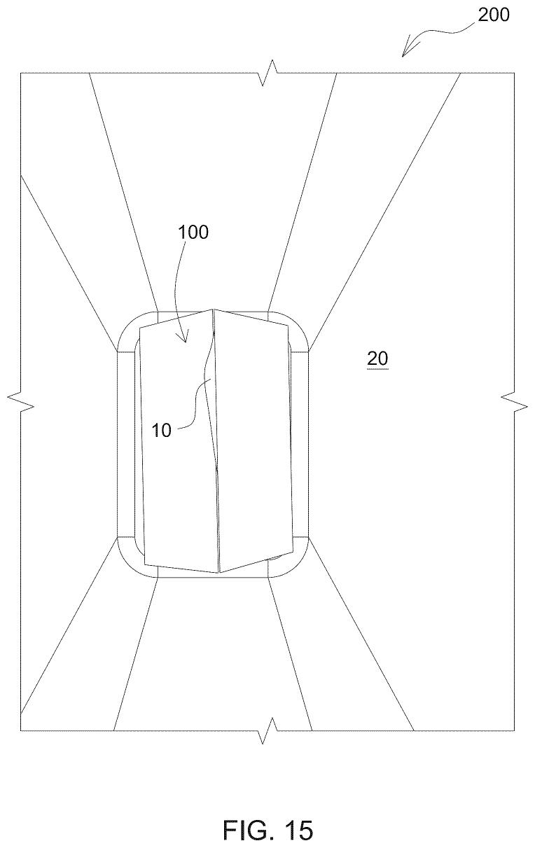

Referring now to FIG. 15, in another optional embodiment of the trash container liner dispenser 100, the trash container liner dispenser may be configured for use in a trash container 20 having a small floor 22. This embodiment of the trash container liner dispenser 100 may not include any end strips 116. Rather, the plurality of supports 118 may be positioned at the end portions 108 of the main body 102. In some examples, the end strips 116 can abut an interior wall of the trash container 20 when the trash container liner dispenser 100 is placed against the floor 22 of the trash container 20, such that the end strips 116 are engagement features that releasably secure the dispenser to the trash container.

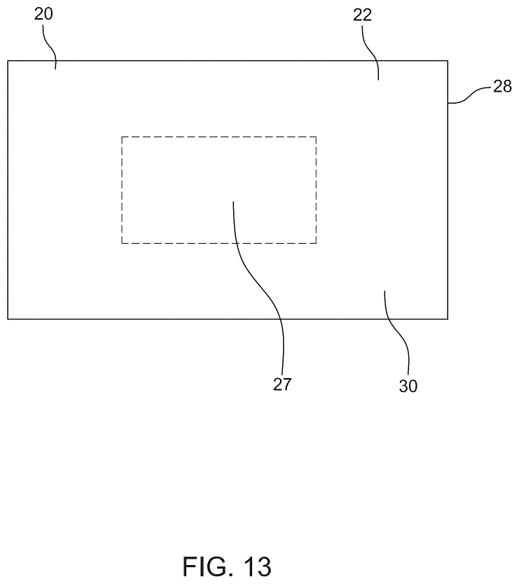

As shown in FIGS. 9 and 13, the trash container liner dispenser 100 may specifically be coupled to a central portion 27 of the floor 22 of the trash container 20. One advantage of this location may be that the roll 12 of trash container liners 10 are protected from waste leakage. When a trash container liner 10 is mounted such that it lines a trash container 20, waste leakage typically occurs around the edge 28 of the trash container 20. Thus, when this waste leakage enters the interior of the trash container 20, it may pool in an outer portion 30 of the floor 22 of the trash container 20. The roll 12 of trash container liners 10 may be protected from contact with the waste leakage by the trash container liner dispenser 100, namely the first wall 110, the second wall 112, and the plurality of supports 118. Moreover, the opening 126 defined in the main body 102 is configured such that it is narrow enough to prevent waste leakage from entering the interior of the trash container liner dispenser 100.

One advantage of the trash container liner dispenser 100 may be that it may be formed to a specialty-made trash container 20 or may be mounted to a prior art trash container 20. Further, the end strips 116 of the trash container liner dispenser 100 may be operable to be separated from the main body 102. It may be desirable to separate the end strips 116 from the main body 102 when the trash container liner dispenser 100 is coupled to a trash container 20 having a small floor 22. The trash container liner dispenser 100 may be removed from one trash container 20 and mounted to a different trash container 20.

Another advantage of the present disclosure may be the ease of manufacture, installation, and use of the trash container liner dispenser 100. A user without special training may install the trash container liner dispenser 100 in a trash container 20. Moreover, the user does not need to purchase specialty trash container liners 10 or configure the trash container liners 10 in any way. The roll 12 of trash container liners 10 may be removed from the product packaging and mounted directly into the trash container liner dispenser 100.

In operation, the trash container liner dispenser 100 may be coupled to the floor 22 of a trash container 20. A user may load a roll 12 of trash container liners 10 into the interior of the trash container liner dispenser 100. When a user needs a new trash container liner 10, the user may pull the outer trash container liner 10 of the roll 12 through the opening 126 of the trash container liner dispenser 100. The outer trash container liner 10 may be separated from the roll 12 at the perforated connection. The user may repeatedly separate trash container liners 10 from the roll 12 until the roll 12 no longer contains any trash container liners 10. The user may then load another roll 12 of trash container liners 10 into the interior of the trash container liner dispenser 100.

One of skill in the art will appreciate that it is within the spirit and scope of the present disclosure for the dispenser 100 to be used in connection with other containers and container liners. In one such exemplary embodiment, the dispenser 100 may be coupled to a laundry container. The dispenser 100 may be configured to receive one or more laundry container liners therein. Specifically, the dispenser 100 may be configured to receive a roll of laundry container liners therein. A user may selectively remove the laundry container liners from the roll to line the laundry container.

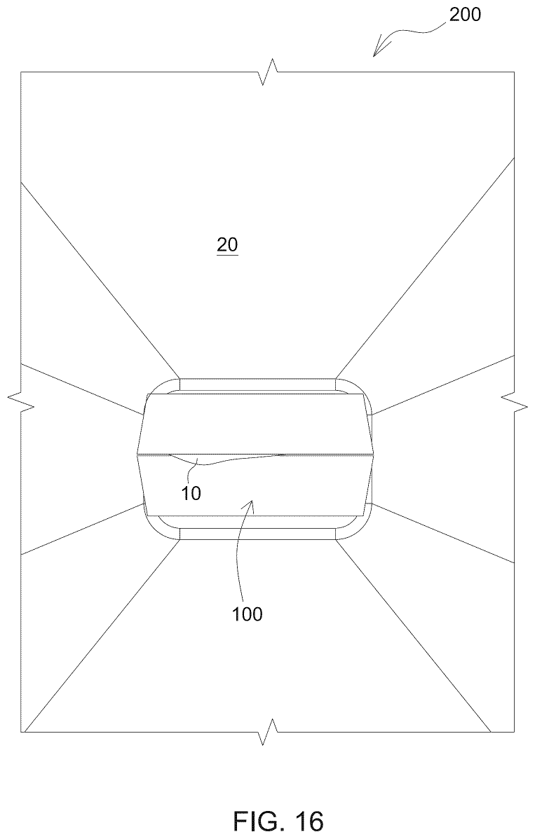

Also disclosed herein are examples of a trash container assembly 200, as illustrated in FIGS. 15-19. The trash container assembly 200 can include a trash container liner dispenser 100 and a trash container 20, which may be permanently or releasably coupled as previously disclosed herein.

The trash container liner dispenser 100 can be configured to contain one or more trash container liners 10, and includes an opening 126 through which the trash container liners 10 may be removed.

According to one aspect of the present disclosure, the trash container liner dispenser 100 can be positioned at the bottom of the trash container 20, and the trash container 20 includes an opening 24 at the bottom of the trash container 20. The opening 24 can be selectively covered by a covering 26 (which in some cases can be a selectively removable cover) disposed over or within the opening 24. The covering 26 can be any sort of covering previously disclosed herein, including a slidable covering, a flexible covering, or a hinged covering.

The trash container liner dispenser 100 can be aligned with the opening 24, such that the trash container liner dispenser 100 can be accessed through the opening 24 when the cover is removed. Thus, the covering 26 can be removed and replaced within the opening 24 to selectively admit or close off access to the trash container liner dispenser 100.

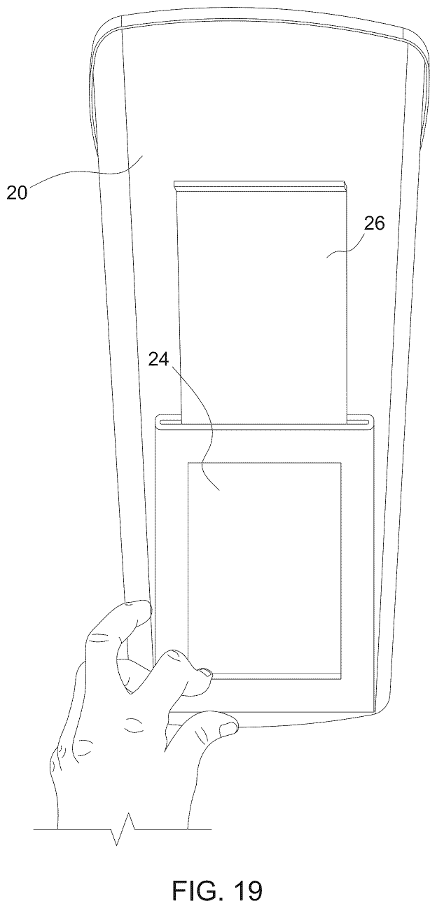

According to one aspect of the present disclosure, the trash container liner dispenser 100 can be positioned along a side portion of the trash container 20. In such examples, as illustrated in FIG. 19, the trash container 20 can include an opening 24 along a side portion of the trash container 20. The opening 24 can be selectively covered by a covering 26 (which in some cases can be a selectively removable cover) disposed over or within the opening 24. The covering 26 can be any sort of covering previously disclosed herein, including a slidable covering, a flexible covering, or a hinged covering.

According to one aspect of the present disclosure, when the trash container liner dispenser 100 and the opening 24 are positioned on a side of the trash container 20, the trash container liner dispenser 100 may be designed so that one of the supports 118 (for example, a support 118 that is upwardly facing when the trash container liner dispenser 100 is mounted to the interior wall of the trash container 20) comprises an aperture. The aperture can admit the a trash container liner from within the trash container liner dispenser 100 to the interior portion of the trash container 20 to allow it to be pulled through the aperture as needed.

According to one aspect of the present disclosure, the covering 26 may slide/translate relative to the trash container 20. The covering 26 may be movable between a closed configuration wherein the covering 26 substantially covers the opening 24 and an open configuration wherein the covering 26 is moved such that the opening 24 is exposed. According to another aspect of the present disclosure, the covering 26 can be a flexible flap attached along one edge to a rim of the opening 24. According to another aspect of the present disclosure, the covering 26 can be mounted to the opening 24 on a hinge, allowing the covering 26 to pivotally move between an open position and a closed position.

It will be appreciated that, in such examples, the trash container liner dispenser 100 can include one or more features to secure the trash container liner dispenser 100 to an interior side of the trash container 20 adjacent to the opening 24. In some examples, the one or more features can match to corresponding features on the interior side of the trash container 20. In other examples, the trash container liner dispenser 100 can be permanently secured to the interior side of the trash container 20.

The trash container liner dispenser 100 can be aligned with the opening 24, such that the trash container liner dispenser 100 can be accessed through the opening 24 when the cover is removed. Thus, the covering 26 can be removed and replaced within the opening 24 to selectively admit or close off access to the trash container liner dispenser 100.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

This written description uses examples to illustrate the various aspects of the disclosed technology, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Example 1. A dispenser for trash container liners, the dispenser comprising: a body having first and second walls, the first and second walls meeting along an apex of the body; an opening defined in the body along a portion of the apex, the opening configured to receive a trash container liner through the opening; and an interior defined by the first and second walls, the interior operable to receive a plurality of the trash container liners; and wherein the dispenser is configured to be coupled to a floor of a trash container at a central portion.

Example 2. The dispenser of any example herein, particularly example 1, further comprising a support extending between the first wall and the second wall, wherein the support, the first wall, and the second wall at least partially define the interior of the dispenser.

Example 3. The dispenser of any example herein, particularly example 2, wherein the support is a first support and the dispenser further comprises a second support laterally spaced apart from the first support along a length of the dispenser, such that a spacing between the first support and the second support defines the length of the interior.

Example 4. The dispenser of any example herein, particularly example 2, further comprising an opening in the support configured to admit the trash container liner to the interior of the dispenser.

Example 5. The dispenser of any example herein, particularly example 2, further comprising one or more end strips extending laterally from the support, wherein the one or more end strips are configured to engage with an interior of a trash container, thereby laterally securing the dispenser within the trash container.

Example 6. The dispenser of any example herein, particularly example 4, further comprising a loading door positioned over or within the opening.

Example 7. The dispenser of any example herein, particularly example 1, further comprising a base extending between a bottom end portion of the first wall and a bottom end portion of the second wall.

Example 8. The dispenser of any example herein, particularly example 1, wherein a bottom portion of the first wall and a bottom portion of the second wall are each permanently coupled to the floor of the trash container.

Example 9. The dispenser of any example herein, particularly example 1, further comprising one or more engagement features located along a bottom portion of the dispenser, wherein the one or more engagement features is configured to selectively couple with the trash container, such that the dispenser is releasably secured to the trash container.

Example 10. The dispenser of any example herein, particularly example 1, wherein the trash container includes an opening defined in a floor of the trash container, wherein the opening is selectively covered by a covering and the opening is configured to admit the trash container liner to the interior of the dispenser.

Example 11. The dispenser of any example herein, particularly example 1, wherein the first wall and the second wall are releasably coupled to each other, and wherein the dispenser further comprises a releasable fastener configured to releasably couple the first wall to the second wall, such that the dispenser can be opened by decoupling the first wall from the second wall.

Example 12. The dispenser of any example herein, particularly example 1, wherein the trash container liner is a first trash container liner of a plurality of trash container liners, and wherein when the first trash container liner is removed from the interior of the dispenser through the opening in the apex, it advances a second trash container liner into the opening.

Example 13. A trash container assembly comprising: a trash container defining an interior space and having an opening in the trash container and selectively removable cover disposed over the opening; a dispenser positioned adjacent to and over the opening, the dispenser comprising: a body having first and second walls, the first and second walls meeting along an apex of the body; an opening defined in the body along a portion of the apex, the opening configured to receive a trash container liner therethrough; and an interior defined by the first wall and the second wall, the interior operable to receive a plurality of the trash container liners; wherein when the selectively removable cover is removed from the opening in the trash container, a trash container liner may be admitted to the interior of the dispenser through the opening.

Example 14. The trash container assembly of any example herein, particularly example 13, wherein the opening is along a floor of the trash container.

Example 15. The trash container of any example herein, particularly example 14, wherein the dispenser is releasably attached to the floor of the trash container.

Example 16. The trash container of any example herein, particularly example 14, wherein the dispenser is permanently attached to the floor of the trash container.

Example 17. The trash container of any example herein, particularly example 14, wherein the dispenser is located in a central portion of the floor of the trash container.

Example 18. The trash container of any example herein, particularly example 13, wherein the selectively removable cover is a flexible flap attached along one edge to a rim of the opening.

Example 19. The trash container of any example herein, particularly example 13, wherein the selectively removable cover is a slidably coupled to the trash container and configured to slide laterally to expose the opening.

Example 20. The trash container assembly of any example herein, particularly example 13, wherein the opening is located in a wall of the trash container.

Thus, although there have been described particular embodiments of the present invention of a new and useful TRASH CONTAINER LINER DISPENSER it is not intended that such references be construed as limitations upon the scope of this invention except as set forth in the following claims.

What is claimed is:

1. A dispenser for trash container liners, the dispenser comprising:
a body having first and second walls, the first and second walls meeting along an apex of the body;
an opening defined in the body along a portion of the apex, the opening configured to receive a trash container liner through the opening; and
an interior defined by the first and second walls, the interior operable to receive a plurality of the trash container liners; and
wherein the dispenser is configured to be coupled to a floor of a trash container at a central portion.

2. The dispenser of claim 1, further comprising a support extending between the first wall and the second wall, wherein the support, the first wall, and the second wall at least partially define the interior of the dispenser.

3. The dispenser of claim 2, wherein the support is a first support and the dispenser further comprises a second support laterally spaced apart from the first support along a length of the dispenser, such that a spacing between the first support and the second support defines the length of the interior.

4. The dispenser of claim 2, further comprising an opening in the support configured to admit the trash container liner to the interior of the dispenser.

5. The dispenser of claim 2, further comprising one or more end strips extending laterally from the support, wherein the one or more end strips are configured to engage with an interior of a trash container, thereby laterally securing the dispenser within the trash container.

6. The dispenser of claim 4, further comprising a loading door positioned over or within the opening.

7. The dispenser of claim 1, further comprising a base extending between a bottom end portion of the first wall and a bottom end portion of the second wall.

8. The dispenser of claim 1, wherein a bottom portion of the first wall and a bottom portion of the second wall are each permanently coupled to the floor of the trash container.

9. The dispenser of claim 1, further comprising one or more engagement features located along a bottom portion of the dispenser, wherein the one or more engagement features is configured to selectively couple with the trash container, such that the dispenser is releasably secured to the trash container.

10. The dispenser of claim 1, wherein the trash container includes an opening defined in a floor of the trash container, wherein the opening is selectively covered by a covering and the opening is configured to admit the trash container liner to the interior of the dispenser.

11. The dispenser of claim 1, wherein the first wall and the second wall are releasably coupled to each other, and wherein the dispenser further comprises a releasable fastener configured to releasably couple the first wall to the second wall, such that the dispenser can be opened by decoupling the first wall from the second wall.

12. The dispenser of claim 1, wherein the trash container liner is a first trash container liner of a plurality of trash container liners, and wherein when the first trash container liner is removed from the interior of the dispenser through the opening in the apex, it advances a second trash container liner into the opening.

13. A trash container assembly comprising:
a trash container defining an interior space and having an opening in the trash container and selectively removable cover disposed over the opening;
a dispenser positioned adjacent to and over the opening, the dispenser comprising:
a body having first and second walls, the first and second walls meeting along an apex of the body;
an opening defined in the body along a portion of the apex, the opening configured to receive a trash container liner therethrough; and
an interior defined by the first wall and the second wall, the interior operable to receive a plurality of the trash container liners;
wherein when the selectively removable cover is removed from the opening in the trash container, a trash container liner may be admitted to the interior of the dispenser through the opening.

14. The trash container assembly of claim 13, wherein the opening is along a floor of the trash container.

15. The trash container of claim 14, wherein the dispenser is releasably attached to the floor of the trash container.

16. The trash container of claim 14, wherein the dispenser is permanently attached to the floor of the trash container.

17. The trash container of claim 14, wherein the dispenser is located in a central portion of the floor of the trash container.

18. The trash container of claim 13, wherein the selectively removable cover is a flexible flap attached along one edge to a rim of the opening.

19. The trash container of claim 13, wherein the selectively removable cover is a slidably coupled to the trash container and configured to slide laterally to expose the opening.

20. The trash container assembly of claim 13, wherein the opening is located in a wall of the trash container.
